(19) United States
(12) Patent Application Publication
(10) Pub. No.: US 2006/0278314 A1
(43) Pub. Date: Dec. 14, 2006

(54) Method of operating vehicular tire-inflation control system

(75) Inventor: Gerhard Skoff, Vienna (AT)

Correspondence Address: THE FIRM OF KARL F ROSS, 5676 RIVERDALE AVENUE, PO BOX 900, RIVERDALE (BRONX), NY, 10471-0900, US

(73) Assignee: STEYR-DAIMLER-PUCH SPEZIALFAHRZEUG GmbH

(21) Appl. No.: 11/447,680

(22) Filed: Jun. 6, 2006

(30) Foreign Application Priority Data
Jun. 9, 2005 (AT) A971/2005

(51) Int. Cl. B60C 29/00

(52) U.S. Cl. 152/415

(57) ABSTRACT

This object is achieved in method of operating a tire-inflation control system connected to tires of a vehicle for increasing and decreasing pressurization of the tires wherein after shutdown of the vehicle engine pressurization of the vehicle tires is increased. The tire pressure is maintained generally at a predetermined set-point level during normal operation of the vehicle, and after shutdown of the engine increasing tire pressure substantially above the set-point level. After restart of the engine pressurization is decreased automatically generally to the set-point level. Tire pressurization is increased with a predetermined delay after shutdown of the engine.

### FIELD OF THE INVENTION

The present invention relates to a method of operating a vehicular tire-inflation control system.

### BACKGROUND OF THE INVENTION

In my U.S. Pat. No. 6,594,566 I describe a vehicular tire-inflation control system wherein tire pressure is automatically checked when the motor vehicle is started. At the same time, the type of operation, either off-road operation or on-road operation, is detected. During the on-road operation of the motor vehicle, the speed of all four wheels is measured and it is made sure whether or not there is an inadmissible difference in wheel speed. If the wheel speeds do not differ, the theoretical tire pressure is determined. If the actual tire pressure differs from the theoretical pressure, inflation/deflation valves of the tires are actuated until the theoretical value is achieved, thereby adjusting the theoretical value. If the wheel speeds differ, as for example, during off-road operation, the vehicle speed is measured and is compared with a threshold value.

Such a system takes into account, in addition to on-and off-road operation, vehicle speed, loading, ground/road conditions, braking actuation, temperature, and many other factors that are detected by standard on-board sensors or special sensors provided for the specific purpose of controlling tire pressure. The goal is to manage the inflation level so that it is optimized for current conditions, even changing pressurization while under way. As such this system is highly effective.

Another issue not addressed by such a system is the so-called flat-spot problem. This is the thumping or vibration that occurs after starting up a vehicle because the vehicle's tires have developed flat spots while standing.

The cause of this is that a tire is made of flexible materials including some, like nylon, that have a short-term plastic memory. Thus after riding for some time the tires will get fairly warm, especially when driving in the summer, so that they will become relatively soft. Such heating up not only softens the tires, but increases their internal pressure. Thus when a vehicle is stopped while its tires are hot, as they cool the pressure in them will decrease so that they will flatten considerably where they engage the ground. As the tires cool this somewhat flattened condition will become set in the plastic material of the tires. When the vehicle is started up again, even if tire pressure is adjusted, this flat spot remains until the tire has gotten warm again. During this warm-up period each wheel produces a sensible thump during each revolution, something that is quite annoying and conceivably even dangerous.

Another problem occurs when a vehicle is parked with one or more tires partially up on the curb or sitting on a rock. In this situation the tire is subject to substantial local deformation. When combined with hot conditions and low tire pressure, such local deformation can lead to separation of the layers making up the tire, and eventually to complete tire failure.

### OBJECTS OF THE INVENTION

It is therefore an object of the present invention to provide an improved method of operating vehicular tire-inflation control system.

Another object is the provision of such an improved method of operating vehicular tire-inflation control system that overcomes the above-given disadvantages, in particular that eliminates or reduces the flat-spot problem.

A further object is to provide a system that protects a vehicle's tires when they are excessively locally deformed, for instance when partly up on a curb, for a relatively long time.

### SUMMARY OF THE INVENTION

These objects are achieved in a method of operating a tire-inflation control system connected to tires of a vehicle for increasing and decreasing pressurization of the tires wherein after shutdown of the vehicle engine pressurization of the vehicle tires is increased.

Thus by this simple expedient any flat spot that might be created will be minimized so that the resultant vibration or thumping will be greatly reduced. The overinflation of the tires is not a problem in a stationary vehicle and is held well below any pressure that could lead to tire failure.

Another substantial advantage of the system of this invention is that it prevents tire damage when, as happens fairly frequently, the vehicle is parked with one or more tires partially up on the curb or sitting on a rock or other highly uneven surface. In this case the warm tire is left deformed for quite some time by this point load, with its entire share of the vehicle weight bearing down on one location in the tire so that layer separation in the tire can result. When such a tire is overinflated while parked according to the invention, such deformation is largely avoided, as is the resultant tire damage.

According to the invention the tire pressure is maintained generally at a predetermined set-point level during normal operation of the vehicle, and after shutdown of the engine increasing tire pressure substantially above the set-point level.

Furthermore according to the invention after restart of the engine pressurization is decreased automatically generally to the set-point level.

According to another feature of the invention tire pressurization is increased with a predetermined delay after shutdown of the engine.

### BRIEF DESCRIPTION OF THE DRAWING

The above and other objects, features, and advantages will become more readily apparent from the following description, reference being made to the accompanying drawing in which:

FIG. 1 is a side view of a vehicle tire with a substantial flat spot as occurs during normal operation;

FIG. 2 is a view like FIG. 1 of a tire with much smaller flat spot, and schematically showing the inflation and control system of this invention; and

FIG. 3 is an end view of the tire as shown in FIG. 2 when partly up on a curb.

### SPECIFIC DESCRIPTION

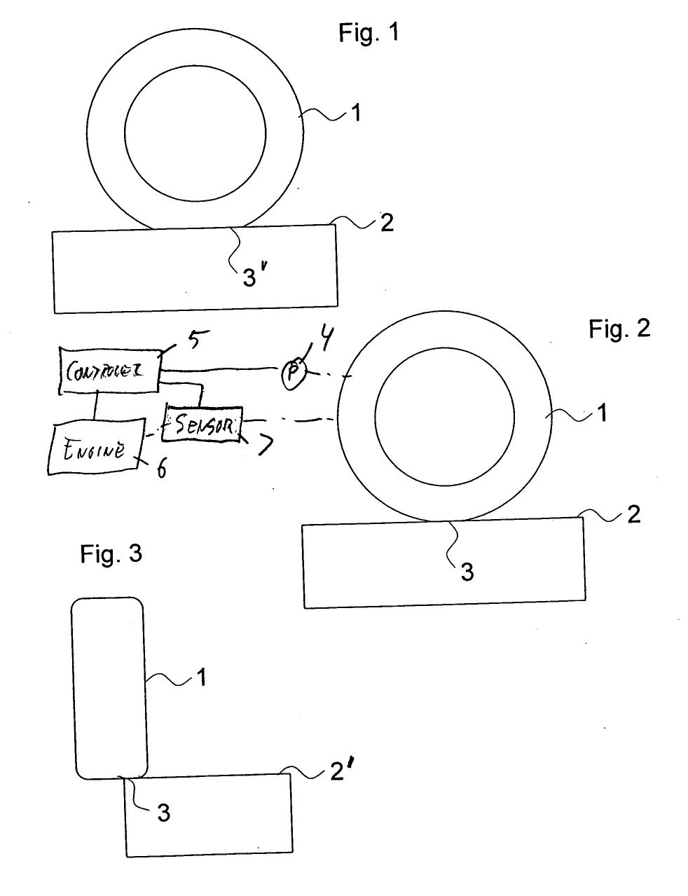

As seen in FIG. 1 a tire 1 sitting on a surface of a street or base 2 normally has a substantial flat spot 3′, here extending over well over 45°. This is the standard operation mode at a pressure in the 25-30 psi range.

FIG. 2 shows how the tire 1, normally one in four on the vehicle, is connected via a valve and pump arrangement 4 to a controller 5. This controller 5, which can simply be part of the standard on-board computer, is also connected to a vehicle engine 6 and to various sensors such as shown at 7 for determining tire pressure, engine condition, temperature, relative wheel speed and such as described in more detail in above-cited U.S. Pat. No. 5,594,566 that is herewith incorporated by reference.

In addition FIG. 2 shows how, after the controller 5 has sensed that the engine 6 has been turned off, and with a suitable delay, it operates the pump/valve arrangement 4 to increase the pressure in each of the tires 1 well above the standard operating or set-point level so that a very small flat spot 3 is left on each tire 1. When the engine 6 is again started, the controller 5 drops the pressure back to the desired level.

FIG. 3 shows how the small flat spot 3 is enough, even when the tire 1 is only partially up on the curb 2′ to prevent substantially deformation of the tire 1. This prevents the layer separation that can occur in a hot tire when it is deformed greatly over a long period.

I claim:

1. A method of operating a tire-inflation control system connected to tires of a vehicle for increasing and decreasing pressurization of the tires, the vehicle having an engine, the method comprising the steps of:
monitoring operation of the engine; and
after shutdown of the engine increasing pressurization of the vehicle tires.

2. The method defined in claim 1 further comprising the steps of:
maintaining tire pressure generally at a predetermined set-point level during normal operation of the vehicle; and
after shutdown of the engine increasing tire pressure substantially above the set-point level.

3. The method defined in claim 2, further comprising the step of
after restart of the engine decreasing pressurization generally to the set-point level.

4. The method defined in claim 1 wherein tire pressurization is increased with a predetermined delay after shutdown of the engine.
